(19) United States
(12) Patent Application Publication
(10) Pub. No.: US 2011/0010165 A1
(43) Pub. Date: Jan. 13, 2011

(54) APPARATUS AND METHOD FOR OPTIMIZING A CONCATENATE RECOGNITION UNIT

(75) Inventors: Yun-Gun PARK, Suwon-si (KR); Eun Sang Bak, Ansan-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/770,878

(22) Filed: Apr. 30, 2010

(30) Foreign Application Priority Data
Jul. 13, 2009 (KR) 10-2009-0063424

(51) Int. Cl. G06F 17/27

(52) U.S. Cl. 704/9

(57) ABSTRACT

An apparatus and method for optimizing a concatenate recognition unit are provided. The apparatus and method of optimizing a concatenate recognition unit may generate an optimized concatenate recognition unit based on a basic language model generated using the concatenate recognition unit extracted from statistical information.

### CROSS-REFERENCE TO RELATED APPLICATION

This application claims the benefit under 35 U.S.C. §119(a) of Korean Patent Application No. 10-2009-0063424, filed Jul. 13, 2009, in the Korean Intellectual Property Office, the entire disclosure of which is incorporated herein by reference for all purposes.

### BACKGROUND

1. Field

The following description relates to a method and apparatus for optimizing a concatenate recognition unit for a vocabulary speech recognition system, for example, and more particularly, to a method and apparatus for optimizing a concatenate recognition unit that may generate a basic language model based on extracted statistical information.

2. Description of the Related Art

A morpheme may be used to extend a speech recognition vocabulary. However, a morpheme may not be suitable for speech recognition if the input utterance is of a short utterance length or duration. To overcome this, a concatenate recognition unit generated by combining morphemes may be used.

Generally, a statistical method may be used for generating a concatenate recognition unit. However, additional generation of concatenate recognition units increases the number of entries of concatenate recognition units in a pronunciation dictionary. Also, the additional information increases the complexity of recognizing speech vocabulary because there are more entries to compare. Thus, additional entries may degrade speech recognition performance.

### SUMMARY

In one general aspect, provided is an apparatus for optimizing a concatenate recognition unit, the apparatus including a statistical information extraction unit to extract statistical information from a Pseudo recognition unit-tagged text corpus, a concatenate recognition unit (CRU) selection unit to select the concatenate recognition unit based on the extracted statistical information, a language model generation unit to process the text corpus using the selected concatenate recognition unit, and to generate a basic language model based on the processed text corpus, and a concatenate recognition unit (CRU) generation unit to extract an optimized concatenate recognition unit based on the generated basic language model, and to generate the extracted optimized concatenate recognition unit as a recognition unit.

The statistical information extraction unit may extract statistical information that includes at least one of frequency information, mutual information, and unigram log-likelihood information, with respect to the recognition unit in the text corpus.

The CRU selection unit may analyze a performance of a concatenate recognition unit from the extracted statistical information, and extract a priority list of the concatenate recognition unit associated with first priority information based on the analyzed performance.

The CRU selection unit may select the concatenate recognition unit from the priority list associated with the first priority information.

The language model generation unit may process the priority list, in association with the text corpus, to generate the basic language model based on the processed text corpus.

The CRU generation unit may include a concatenate recognition unit (CRU) optimization unit to analyze second priority information of the concatenate recognition unit from the generated basic language model and to extract the optimized concatenate recognition unit.

The CRU optimization unit may analyze the second priority information from probability summation information or context information of the concatenate recognition unit, the probability summation information or the context information being from the generated basic language model.

The CRU optimization unit may reorder the concatenate recognition unit on the priority list based on the second priority information.

The CRU optimization unit may remove concatenation of concatenate recognition units that are not generated in the generated basic language model.

The probability summation information may be a probability sum of a recognition unit with respect to the concatenate recognition units generated in the generated basic language model.

The CRU optimization unit may remove concatenation of concatenate recognition units that are not generated in the generated basic language model, from the second priority information about the sum of probability for each recognition unit.

The context information may be one or more context factors for each recognition unit generated in the basic language model.

The CRU optimization unit may remove concatenation of concatenate recognition units that are not generated in the generated basic language model, from the second priority information based on the one or more context factors for each recognition unit.

The CRU generation unit may update a language model and a pronunciation dictionary based on the extracted optimized concatenate recognition unit.

The CRU generation unit may retrain an acoustic model based on the extracted optimized concatenate recognition unit.

In another aspect, there is provided a method for optimizing a concatenate recognition unit, the method including extracting statistical information from a Pseudo recognition unit-tagged text corpus, selecting a concatenate recognition unit based on the extracted statistical information, processing the text corpus using the selected concatenate recognition unit, and generating a basic language model based on the processed text corpus, and extracting an optimized concatenate recognition unit based on the generated basic language model, and generating the extracted optimized concatenate recognition unit as an optimized concatenate recognition unit.

The selecting may include analyzing a performance of the concatenate recognition unit from the extracted statistical information, and extracting a priority list of the concatenate recognition unit associated with first priority information based on the analyzed performance.

The generating of the basic language model may include processing the priority list to in association with the text corpus to generate the basic language model.

The generating of the extracted optimized concatenate recognition unit may include analyzing second priority information of the concatenate recognition unit from the generated basic language model, and extracting the optimized concatenate recognition unit.

In another aspect, there is provided a computer-readable recording medium storing instructions to a cause a processor to perform a method including extracting statistical information from a Pseudo recognition unit-tagged text corpus, selecting a concatenate recognition unit based on the extracted statistical information, processing the text corpus using the selected concatenate recognition unit, and generating a basic language model based on the processed text corpus, and extracting an optimized concatenate recognition unit based on the generated basic language model, and generating the extracted optimized concatenate recognition unit as an optimized concatenate recognition unit.

Other features and aspects will be apparent from the following detailed description, the drawings, and the claims.

### BRIEF DESCRIPTION OF THE DRAWINGS

FIG. 1 is a diagram illustrating an example of an apparatus for optimizing a concatenate recognition unit.

FIG. 2 is a flowchart illustrating an example of a method for optimizing a concatenate recognition unit.

FIG. 3 is a flowchart illustrating another example of a method for optimizing a concatenate recognition unit.

FIG. 4 is a flowchart illustrating an example of a method for extracting an optimized concatenate recognition unit.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the apparatuses, methods, and/or systems described herein. Accordingly, various changes, modifications, and equivalents of the apparatuses, methods, and/or systems described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

A “concatenate recognition unit” is a recognition unit that includes combined linguistic units, for example, linguistic units having a semantic meaning. In some embodiments, the linguistic units may be combined according to a predetermined standard.

A “Pseudo recognition unit” is a recognition unit that may maintain linguistic characteristics and a sound value of a given phrase for each recognition unit based on the concatenate recognition unit.

The “recognition unit” used herein may be one or more morphemes, the “concatenate recognition unit” may be a concatenate morpheme, and the “Pseudo recognition unit” may be a Pseudo morpheme.

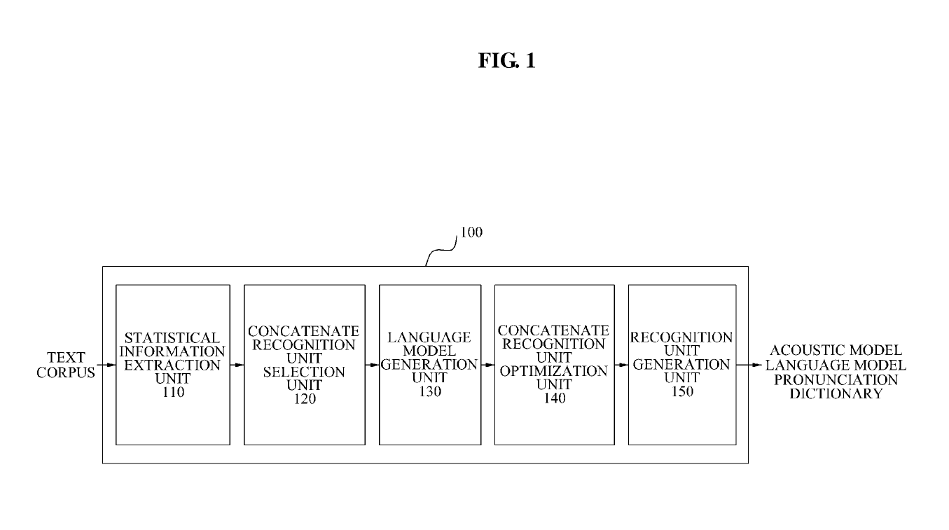

FIG. 1 illustrates an example of an apparatus for optimizing a concatenate recognition unit (“CRU”). The apparatus may be used in a large vocabulary continuous speech recognition system.

Referring to FIG. 1, the example apparatus 100 for optimizing a concatenate recognition unit, hereinafter referred to as the apparatus 100, may include a statistical information extraction unit 110, a concatenate recognition unit (CRU) selection unit 120, a language model generation unit 130, and a concatenate recognition unit (CRU) generation unit 150. In some embodiments, the apparatus 100 may include a concatenate recognition unit (CRU) optimization unit 140.

The statistical information extraction unit 110 extracts statistical information. For example, the statistical information extraction unit 110 may extract information from Pseudo recognition unit-tagging text corpus. The statistical information extraction unit 110 may extract statistical information including, for example, at least one of frequency information, mutual information, and unigram log-likelihood information, with respect to the one or more recognition units in the text corpus.

The CRU selection unit 120 selects a concatenate recognition unit based on the extracted statistical information. For example, the CRU selection unit 120 may analyze a performance of a concatenate recognition unit from the extracted statistical information. The CRU selection unit 120 may extract a priority list of the concatenate recognition unit associated with first priority information based on the analyzed performance. The concatenation of recognition units may be determined based on an arrangement of the extracted priority list. For example, the CRU selection unit 120 may select the concatenate recognition unit from the priority list associated with the first priority information.

The language model generation unit 130 processes the text corpus using the selected concatenate recognition unit, and generates a basic language model based on the processed text corpus. For example, the language model generation unit 130 may process the priority list, in association with the text corpus to generate the basic language model based on the processed text corpus. The basic language model may be a language model based on the statistical information.

The CRU generation unit 150 extracts a concatenate recognition unit based on the generated basic language model, and generates the concatenate recognition unit as a concatenate recognition unit.

The CRU generation unit 150 may include a concatenate recognition unit (CRU) optimization unit 140. The CRU optimization unit 140 may analyze second priority information of the concatenate recognition unit from the generated basic language model and may extract an optimized concatenate recognition unit, based on second priority information.

For example, the CRU optimization unit 140 may analyze the second priority information that may include, for example, probability summation information, context information, and the like, of the concatenate recognition unit. The second priority information may be analyzed from the basic language model generated by the language model generation unit 130.

In some embodiments, the CRU optimization unit 140 may reorder the concatenate recognition unit in the priority list, based on the second priority information. For example, the CRU optimization unit 140 may remove concatenation of concatenate recognition units which are not generated in the generated basic language model.

The probability summation information may be a probability sum of a recognition unit with respect to the concatenate recognition unit generated in the basic language model. The CRU optimization unit 140 may analyze the probability sum of the concatenate recognition unit generated in the basic language model generated by the language model generation unit 130. The CRU optimization unit 140 may remove concatenation of concatenate recognition units that are not generated in the generated basic language model, from the second priority information, based on the probability sum of a recognition unit.

When the concatenate recognition unit is not generated in the basic language model, the probability sum may be zero. When the concatenate recognition unit is generated in the basic language model, the probability summation information may have a predetermined value. The CRU optimization unit 140 may remove a concatenate recognition unit from the priority list, for example, a concatenate recognition unit having a probability sum of zero.

The context information may include a context factor with respect to the recognition unit. For example, the context information may include one or more context factors for each recognition unit generated in the basic language model. The CRU optimization unit 140 may analyze information about the one or more context factors for each recognition unit included in the priority list. The CRU optimization unit 140 may remove concatenation of a concatenate recognition unit that is not generated in the generated basic language model, from the second priority information, based on the one or more context count factors for each recognition unit.

When the concatenate recognition unit is not generated in the basic language model, the context information may be zero. When the concatenate recognition unit is generated in the basic language model, the context information may have a predetermined value. CRU optimization unit 140 may remove a concatenate recognition unit from the priority list, for example, a concatenate recognition unit having a context information of zero.

The CRU optimization unit 140 may reorder the concatenate recognition unit on the priority list based on the second priority information, to optimize a concatenate recognition unit list. The CRU optimization unit 140 may optimize the priority list according to the second priority information, for example, probability summation information, the context information, and the like. The CRU optimization unit 140 is not limited to the examples describe above. For example, the CRU generation unit 150 may update a language model and a pronunciation dictionary based on the extracted optimized concatenate recognition unit as the concatenate recognition unit. Also, for example, the CRU generation unit 150 may retrain an acoustic model based on the extracted optimized concatenate recognition unit as the recognition unit.

As illustrated in the example apparatus 100 of FIG. 1, each of the statistical information extraction unit 110, the CRU selection unit 120, language model generation unit 130, CRU optimization unit 140, and the CRU generation unit 150, are illustrated as individual modules for convenience. However, one or more of the modules may be combined in the apparatus 100, for example, the CRU optimization unit 140 may be combined with the CRU generation unit 150.

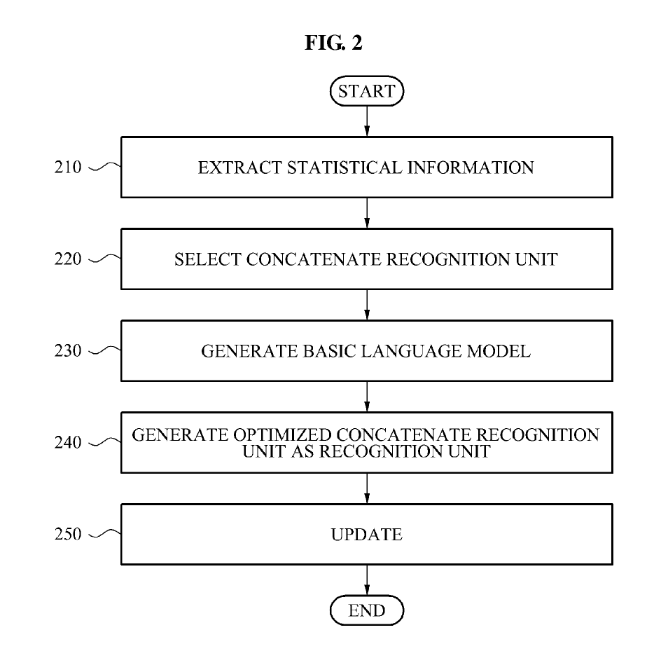

FIG. 2 is a flowchart that illustrates an example of a method for optimizing a concatenate recognition unit. Referring to FIG. 2, in operation 210, the method of optimizing a concatenate recognition unit, hereinafter referred to as the method, extracts statistical information. The statistical information may be extracted from various types of voice recognition information, for example, Pseudo recognition unit-tagged text corpus.

In operation 210, the method may extract the statistical information including, for example, at least one of frequency information, mutual information, and unigram log-likelihood information with respect to a recognition unit in the text corpus.

In operation 220, the method selects a concatenate recognition unit based on the extracted statistical information. For example, the method may analyze a performance of the concatenate recognition unit from the extracted statistical information, and extract a priority list of the concatenate recognition unit associated with first priority information based on the analyzed performance. Also, in operation 220, the method may select the concatenate recognition unit from the priority list associated with the first priority information.

In operation 230, the method processes the text corpus using the selected concatenate recognition unit, and generates a basic language model based on the processed text corpus. For example, the method may process the priority list, in association with the text corpus to generate the basic language model based on the processed text corpus.

In operation 240, the method extracts an optimized concatenate recognition unit based on the generated basic language model, and generates the extracted optimized concatenate recognition unit as a recognition unit. For example, the method may analyze second priority information of the concatenate recognition unit from the generated basic language model and extract the optimized concatenate recognition unit. The method may analyze the second priority information that includes, for example, probability summation information, context information, and the like, of the concatenate recognition unit. The second priority information may be analyzed from the basic language model.

In some embodiments, in operation 240, the method may reorder the concatenate recognition unit on the priority list based on the second priority information. For example, the method may remove concatenation of concatenate recognition units which are not generated in the generated basic language model. In operation 240, the method may reorder the concatenate recognition unit on the priority list based on the second priority information, to optimize a concatenate recognition unit list.

In operation 250, the method updates a language model and a pronunciation dictionary based on the extracted optimized concatenate recognition unit as the recognition unit.

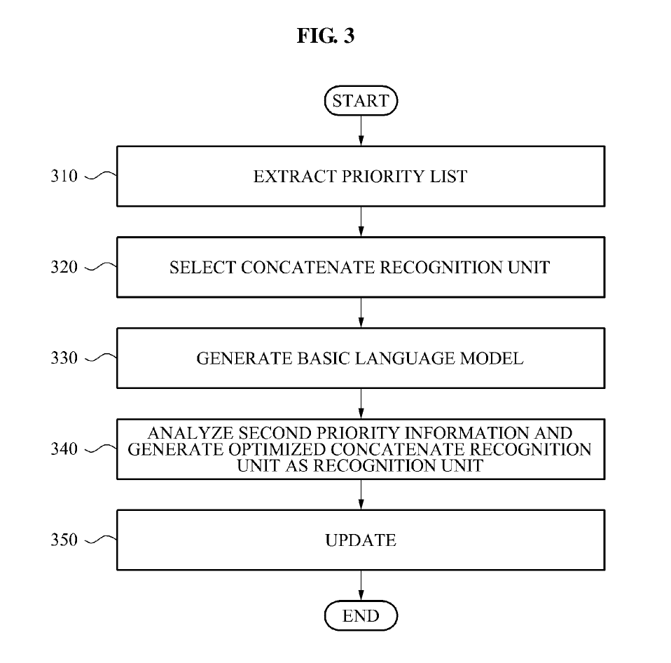

FIG. 3 is a flowchart that illustrates another example of a method for optimizing a concatenate recognition unit.

Referring to FIG. 3, in operation 310, the method may analyze a performance of the concatenate recognition unit from statistical information, and extracts a priority list of the concatenate recognition unit associated with first priority information based on the analyzed performance. The statistical information may be extracted from various types of voice recognition information, for example, Pseudo recognition unit-tagged text corpus.

In operation 320, the method may select the concatenate recognition unit from the priority list associated with the first priority information.

In operation 330, the method may process the priority list, in association with the text corpus, and generate the basic language model based on the processed text corpus.

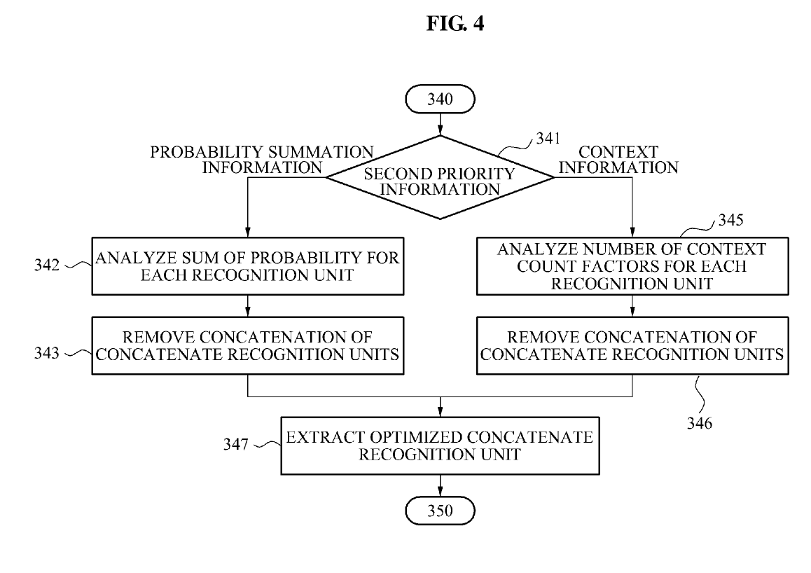

In operation 340, the method may analyze second priority information of the concatenate recognition unit from the generated basic language model, and extract the optimized concatenate recognition unit. Hereinafter, an operation of extracting the optimized concatenate recognition unit is described in with reference to FIG. 4.

FIG. 4 is a flowchart that illustrates a method for extracting an optimized concatenate recognition unit.

Referring to FIG. 4, in operation 340, the method may analyze the second priority information including probability summation information, context information, and the like, of the concatenate recognition unit. The second priority information may be analyzed from the basic language model.

In operation 341, the method may determine an analysis basis for the second priority information. In operation 342, when the analysis basis is the probability summation information, the method may analyze a sum of probability of the concatenate recognition unit generated in the basic language model.

For example, the probability summation information may be a probability sum of a recognition unit with respect to the concatenate recognition unit generated in the basic language model.

In operation 343, the method may remove concatenation of concatenate recognition units that are not generated in the generated basic language model, from the second priority information, based on the probability sum of a recognition unit.

When the concatenate recognition unit is not generated in the basic language model, the probability sum may be zero. When the concatenate recognition unit is generated in the basic language model, the probability summation information may have a predetermined value. For example, in operation 343, the method may remove a concatenate recognition unit from the priority list having a probability sum of zero.

In operation 347, the method may extract an optimized concatenate recognition unit based on the generated basic language model. For example, in operation 347, the method may reorder the concatenate recognition unit on the priority list based on the second priority information, to optimize a concatenate recognition unit list.

In some embodiments, the method may determine an analysis basis for the second priority information including context information, in operation 341. The method may analyze one or more context factors generated in the basic language model, in operation 345. For example, the method may analyze information about the one or more context factors for each recognition unit included in the priority list.

In operation 346, the method may remove concatenation of concatenate recognition units, which are not generated in the generated basic language model, from the second priority information, based on the one or more context factors for each recognition unit.

When the concatenate recognition unit is not generated in the basic language model, the context information may be zero. When the concatenate recognition unit is generated in the basic language model, the context information may have a predetermined value. In operation 346, the method may remove a concatenate recognition unit from the priority list, for example, a concatenate recognition unit having a context information of zero.

In operation 347, the method may extract an optimized concatenate recognition unit based on the basic language model. For example, in operation 347, the method may reorder the concatenate recognition unit on the priority list based on the second priority information, to optimize the concatenate recognition unit list.

Referring again to FIG. 3, in operation 350, the method may update a language model and a pronunciation dictionary based on the extracted optimized concatenate recognition unit, and retrain an acoustic model.

An apparatus and method of optimizing a concatenate recognition unit may be used to efficiently optimize a concatenate recognition unit, remove an inactive concatenate recognition unit, and reduce complexity of a pronunciation dictionary. The apparatus and method of optimizing a concatenate recognition unit may improve a speech recognition performance.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer system connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for optimizing a concatenate recognition unit, the apparatus comprising:
a statistical information extraction unit configured to extract statistical information from a Pseudo recognition unit-tagged text corpus;
a concatenate recognition unit (CRU) selection unit configured to select the concatenate recognition unit based on the extracted statistical information;
a language model generation unit configured to process the text corpus using the selected concatenate recognition unit, and to generate a basic language model based on the processed text corpus; and
a concatenate recognition unit (CRU) generation unit configured to extract an optimized concatenate recognition unit based on the generated basic language model, and to generate the extracted optimized concatenate recognition unit as a recognition unit.

2. The apparatus of claim 1, wherein the statistical information extraction unit is further configured to extract statistical information that includes at least one of frequency information, mutual information, and unigram log-likelihood information, with respect to the recognition unit in the text corpus.

3. The apparatus of claim 1, wherein the CRU selection unit is further configured to:
analyze a performance of a concatenate recognition unit from the extracted statistical information; and
extract a priority list of the concatenate recognition unit associated with first priority information based on the analyzed performance.

4. The apparatus of claim 3, wherein the CRU selection unit is further configured to select the concatenate recognition unit from the priority list associated with the first priority information.

5. The apparatus of claim 3, wherein the language model generation unit is further configured to process the priority list, in association with the text corpus, to generate the basic language model based on the processed text corpus.

6. The apparatus of claim 3, wherein the CRU generation unit comprises a concatenate recognition unit (CRU) optimization unit configured to:
analyze second priority information of the concatenate recognition unit from the generated basic language model; and
extract the optimized concatenate recognition unit.

7. The apparatus of claim 6, wherein the CRU optimization unit is further configured to analyze the second priority information from probability summation information or context information of the concatenate recognition unit, the probability summation information or the context information being from the generated basic language model.

8. The apparatus of claim 7, wherein the CRU optimization unit is further configured to reorder the concatenate recognition unit on the priority list based on the second priority information.

9. The apparatus of claim 7, wherein the CRU optimization unit is further configured to remove concatenation of concatenate recognition units that are not generated in the generated basic language model.

10. The apparatus of claim 7, wherein the probability summation information comprises a probability sum of a recognition unit with respect to the concatenate recognition units generated in the generated basic language model.

11. The apparatus of claim 10, wherein the CRU optimization unit is further configured to remove concatenation of concatenate recognition units that are not generated in the generated basic language model, from the second priority information about the sum of probability for each recognition unit.

12. The apparatus of claim 7, wherein the context information comprises one or more context factors for each recognition unit generated in the basic language model.

13. The apparatus of claim 12, wherein the CRU optimization unit is further configured to remove concatenation of concatenate recognition units that are not generated in the generated basic language model, from the second priority information based on the one or more context factors for each recognition unit.

14. The apparatus of claim 1, wherein the CRU generation unit is further configured to update a language model and a pronunciation dictionary based on the extracted optimized concatenate recognition unit.

15. The apparatus of claim 1, wherein the CRU generation unit is further configured to retrain an acoustic model based on the extracted optimized concatenate recognition unit.

16. A method for optimizing a concatenate recognition unit, the method comprising:
extracting statistical information from a Pseudo recognition unit-tagged text corpus;
selecting a concatenate recognition unit based on the extracted statistical information;
processing the text corpus using the selected concatenate recognition unit;
generating a basic language model based on the processed text corpus;
extracting an optimized concatenate recognition unit based on the generated basic language model; and
generating the extracted optimized concatenate recognition unit as an optimized concatenate recognition unit.

17. The method of claim 16, wherein the selecting comprises:
analyzing a performance of the concatenate recognition unit from the extracted statistical information; and
extracting a priority list of the concatenate recognition unit associated with first priority information based on the analyzed performance.

18. The method of claim 17, wherein the generating of the basic language model comprises processing the priority list in association with the text corpus to generate the basic language model.

19. The method of claim 17, wherein the generating of the extracted optimized concatenate recognition unit comprises:
analyzing second priority information of the concatenate recognition unit from the generated basic language model; and
extracting the optimized concatenate recognition unit.

20. A computer-readable recording medium storing instructions to a cause a processor to perform a method, comprising:
extracting statistical information from a Pseudo recognition unit-tagged text corpus;
selecting a concatenate recognition unit based on the extracted statistical information;
processing the text corpus using the selected concatenate recognition unit;
generating a basic language model based on the processed text corpus;
extracting an optimized concatenate recognition unit based on the generated basic language model; and
generating the extracted optimized concatenate recognition unit as an optimized concatenate recognition unit.
